(19) United States
(12) Patent Application Publication
(10) Pub. No.: US 2017/0076566 A1
(43) Pub. Date: Mar. 16, 2017

(54) Security 3 Lockbox (aka S3 Lockbox)

(71) Applicant: Michelle R. Pursell, Cedar Hills, UT (US)

(72) Inventor: Michelle R. Pursell, Cedar Hills, UT (US)

(21) Appl. No.: 14/853,760

(22) Filed: Sep. 14, 2015

(51) Int. Cl. G08B 13/02; G08B 25/12; G06F 21/32

(52) U.S. Cl. CPC G08B 13/02; G06F 21/32; G08B 25/12

(57) ABSTRACT

Fingerprint (Thumbprint) (Include Retina Scan & Voice Recognition & whole hand scan) secured electronic lockbox for Real Estate (professional & personal use) with tracking & reporting technology, is disclosed. This device offers 100% verifiable ID of who is opening the lockbox. Provides easier, more convenient access to properties while providing the most secure method of protecting that property's access. While created primarily for Real Estate Professionals to replace all current electronic lockbox systems on the market, this device will be available for non-real estate professionals as well.

### BACKGROUND OF THE INVENTION

Problem Solved: Real Estate Lockboxes use external devices to unlock the key box—it requires juggling extra parts plus people can use someone else's key code/device to get into the properties with no way to trace who really went inside. Combination locks or key locks can be easily cut off—allowing anyone access to the property.

External keypads or key cards require charging, can be lost, or can be used by others with no way to verify who is really entering the property.

This lockbox/Keybox offers 100% verifiable ID of who is opening the lockbox as well as a tracking database to keep records all activities with each lockbox/keybox. The agent/contractor/property owner doesn't need to remember to bring any special devices to get into the box and it doesn't need charged.

The lockbox/keybox will have a security feature allowing the person opening the box under duress to use a pre-determined different finger for identification purposes which will still unlock the keybox but it will notify 911 of the address where the keybox is located. Likewise, there can be a small remote panic button that the box owner can carry on their keyring or in their pocket and press the panic button if they're inside the property and being attacked—this will remotely notify 911 as well.

### DETAILED DESCRIPTION OF THE INVENTION

As stated above, Real Estate Lockboxes/Keyboxes use external devices to unlock the key box—it requires juggling extra parts plus people can use someone else's key code/device to get into the properties with no way to trace who really went inside. Personal pad locks or combination locks can be easily cut off. Or combinations/codes can be shared with no way to verify who REALLY entered the property. The invention claimed here solves this problem.

Fingerprint scanner (or Retina, voice, hand scanners) on lockboxes offers a Secured way to open lockbox & verify who is REALLY entering the property. No external devices to charge, lose, forget, etc. Can replace the need for pad locks and other combination key boxes as well.

The claimed invention differs from what currently exists. No external devices needed. No way to “cheat” the system by sharing or using someone else's key card or code. This provides a safe & secure way to verify the Agent/contractor/property owner is actually the one entering the property. The interchangeable head/handle provides three different sizes to easily fit almost any door knob or latch needing secured. If the lockbox is cut off the box owner will be notified immediately. This lockbox has special security features allowing the box owner/user to scan a different predetermined finger if being forced to open the box under duress which notifies 911 or if the box owner/user is already inside the property, they may use the remote notification method offered which will also notify 911.

### The Version of the Invention Discussed Here Includes

1. Fingerprint/Retinal/Voice Technology incorporated into an electronic lightweight, weather proof & virtually destruction proof lockbox/keybox (reserve the rights to use Retina, voice and/or hand scan technology incorporated into an electronic lockbox/keybox as well.)
2. That communicates wirelessly with the system and 911.
3. The system will be a cloud based database which tracks and allows the agents to track where their lockbox is and who has opened it and when it was opened.
4. The box itself will be self-contained and have a roomy key compartment.

### Relationship Between the Components

Step 1 is to be merged with Steps 2, 3 & 4. The physical lockbox must be created for the Fingerprint/Retinal/Voice scanner to be merged into it. Then the software/database system must be created and integrated with the lockbox technology.

### How the Invention Works

The physical lockbox must be created for the Fingerprint/Retinal/Voice scanner to be merged into it. Then the software/database system must be created and integrated with the lockbox technology. Once created and merged together, a Realtor, Contractor, or Property Owner can register their finger or thumb print with the system via the software. A Realtor, Contractor, or Property Owner enters which lockbox they are putting on which property into the system using the assigned ID number on the lockbox itself. When the Realtor, Contractor, or Property Owner enters a property, the system tracks which lockbox they opened. Realtors, Contractors, or Property Owners can view in the system who entered their listings and can also reassign lockboxes to new listings without losing the data of who entered the previous listing . . . The computer program created for use with this system will also include a lockout feature for individuals, specific trades, realtors after a certain time period or indefinitely for everyone except the owner of the lockbox and their Real Estate Broker or anyone assigned to have unlimited access. If the device is cut off or damaged, the lockbox owner will be notified.

The software technology to be used along with the lockbox will be cloud based and able to track each lockbox, assign it to particular properties, set times for use and allow limitations and lockout time frames as well as lockout particular people. The software will house each person's identification with the highest security and only those who register will be able to use the lockboxes/keyboxes or software. The software will track who opens each particular keybox/lockbox. The software will notify the owner of each lockbox/keybox via their preferred method of contact in the event the box is tampered with in anyway and when the internal battery is low. There is also a security feature notifying 911 of an emergency. Additional features of the software may be added or changed without affecting this patent or its rights of use.

### How to Make the Invention

Fingerprint scanners & technology already exist but the design of how to get the best print needs to be created. Likewise, “marrying” this technology with the lockbox/keybox is what makes this invention unique and improves the way people/businesses will secure their properties for now on.

Creating the actual electronic lock box should be constructed from material that cannot be broken or damaged, and extreme weather proof, with interchangeable handles to adjust size, the key compartment will slide or flip open and not be completely removable and with a sleek design that hangs on most door knobs without damaging the door (hard rubber trim). Then the software needs to be created and integrated with the lockbox.

The Software will be a cloud based database tracking & recording system allowing the owner of the lockbox to control the use of their boxes and allowing them to easily see who is opening their box as well as assign or lockout specific people, specific hours, etc.

All elements are necessary.

Someone trying to infringe on our design could use retina scan or voice detection instead of finger prints. Which is why we have added this option to our patent so we can use these technologies if desired but no one else can come in and do so.

The actual physical design (size, shape, color, material, etc) of the lockbox is not specific and can be changed or altered within this patent so long as the ideology and combinations of the scan technology into a keybox remain as stated.

### How to Use the Invention

This invention could be used on a larger scale to securely gain access to office, government buildings or even jails through the doors themselves instead of a lockbox. But its still all secured entry and tracking. The primary purpose of this device is to provide a Safe & Secure way to provide access to any property as granted by the device owner. Individuals/Businesses will purchase the lockboxes/keyboxes and will own them while paying for the licensing rights to use the “system” for their tracking needs.

1. (canceled)

2. (canceled)

3. (canceled)

1. (canceled)

2. (canceled)

3. (canceled)

4. (canceled)

5. (canceled)

6. (canceled)

7. (canceled)

8. Secure lockbox system comprising of cloud based tracking & secure database, comprising of added emergency features using a Retina Scan, FingerPrint scan and/or voice identification technology incorporated into the lockbox/keybox.

9. Additional feature comprising of a handheld style remote device to trigger a silent alarm.

10. As in claim #8, said S3 lockbox comprising of a fingerprint/retina scan and/or voice identification technology incorporated into an electronic lightweight, extreme weatherproof & virtually indestructible lockbox/keybox.

11. As in claim #8, further including the cloud based system comprising of the ability for the registered user to choose which specific identifying feature they want to use for normal entry of the lockbox and for the silent emergency notification. For example: Registered user normally uses his right middle finger to open the lockbox using the fingerprint technology. However, if the registered user is being forced to open the lockbox under duress, he would open the box using his predetermined emergency finger (let's say his right index finger). The box would open normally but a silent notification would be sent to 911 operators (if available in the area) or to any emergency person/company predetermined for that registered user.

12. As in claim #8, further including, The lockbox itself is comprised of multiple interchangeable sized heads or tops to be able to secure to almost any type of door or even a padlock and Comprising of an internal locking mechanism.

13. As in claim #8, The lockbox system is comprising of a cloud based system using GPS technology to track the location of the lockbox & to be able to notify 911 or emergency contact if user is in destress.

14. Referring to claim #9 above, the remote feature comprising of a silent alarm signal to the lockbox. It is a device that can be purchased separately which the registered user can carry on a keyring or in his/her pocket. In case of an emergency situation after the registered user has already opened the lockbox, the registered user can press the remote device and it will trigger the silent alarm notification to the 911 operator or the person/entity of the user's choice.
